(19) United States
(12) Patent Application Publication
(10) Pub. No.: US 2004/0207576 A1
(43) Pub. Date: Oct. 21, 2004

(54) Spacer discharging apparatus and method of field emission display

(75) Inventor: Seong Hak Moon, Seoul (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/826,231

(22) Filed: Apr. 16, 2004

(30) Foreign Application Priority Data
Apr. 18, 2003 (KR) 10-2003-0024773

(51) Int. Cl. G09G 3/22

(52) U.S. Cl. 345/75.2

(57) ABSTRACT

A spacer discharging apparatus and method of an FED are disclosed in which a pulse control signal synchronized with a vertical synchronous signal is outputted during a blanking time period. In the spacer discharging apparatus, a discharge path is formed to connect an anode electrode and a spacer ground electrode of an FED and a switch unit selectively connects the discharge path. Electric charge charged in the spacer is quickly discharged, so that generation of noise or visible appearance of the spacer can be prevented.

### BACKGROUND OF THE INVENTION

1. Field of the Invention

The present invention relates to an FED (Field Emission Display) and more particularly, to a spacer discharging apparatus and method of an FED capable of improving a display quality by discharging a spacer of the FED.

2. Description of the Background Art

In general, as the information processing systems are developed and widely spread, a display device as a time information transmission means has increasing importance. Of display devices, researches are actively ongoing on a flat panel display such as a liquid crystal display (LCD), a plasma display panel (PDP) and the FED or the like.

Especially, the FED, which is anticipated to be commercialized in the near future, receives much attention as a flat panel display for a next-generation information communications.

The FED includes a front substrate having a fluorescent material and an anode electrode and a back substrate having a gate electrode and a cathode electrode. In addition, in the FED, the distance between the front substrate and the back substrate is approximately 1˜2 mm, short, so that a high electric field is formed by a high voltage applied to the anode electrode. Accordingly, in the FED, electrons discharged by a difference between voltages applied to the gate electrode and the cathode electrode formed on the back substrate are drawn by the electric field formed by the high voltage-applied anode electrode, to excite the fluorescent material so as to be emitted.

The construction of the FED in accordance with the conventional art will now be described with reference to FIG. 1.

FIG. 1 is a sectional view showing the construction of the FED in accordance with the conventional art.

As shown in FIG. 1, the conventional FED includes a back substrate 10 having a cathode electrode 12, a dielectric layer 13 and a gate electrode 14 sequentially stacked on a lower glass substrate 11; and a front substrate 20 having an anode electrode 22 and a phosphor 23 sequentially stacked on an upper glass substrate 21.

A spacer 30 is positioned between the upper glass substrate 21 and the lower glass substrate 11 to maintain a certain distance therebetween. In addition, spacers 30 are distributively and evenly positioned on the entire surface of the front substrate 20 and the back substrate 10 so as to sufficiently tolerate a difference between an external atmospheric pressure and an atmospheric pressure according to high vacuum at the inner side thereof.

The conventional FED operates as follows.

First, when a certain voltage is applied to the gate electrode 14 and the cathode electrode 12, electrons are discharged from the cathode electrode 12 and the discharged electrons passes through the gate electrode 14 so as to be discharged by a quantum-mechanical tunneling effect. At this time, if the applied voltage is relatively high, the amount of electrons discharged from the cathode electrode 12 is increased, while if the applied voltage is relatively low, the amount of electrons discharged from the cathode electrode 12 is decreased.

Thereafter, the electrons discharged from the cathode electrode 12 are accelerated toward the anode electrode 22 with the phosphor 23 coated thereon by being influenced by the electric field formed by the high voltage applied to the anode electrode 22. Accordingly, electrons collide with the phosphor 23 to generate an energy.

Electrons existing in the phosphor 23 are excited by the generated energy to emit visible light.

FIG. 2 is a plan view showing the structure of the FED in accordance with the conventional art.

As shown in FIG. 2, the conventional FED includes a scan electrode 12A applying a scan voltage to the cathode electrode 12; a data electrode 14A applying a data voltage to the gate electrode 14; and a high voltage power source unit 31 applying a high voltage to the anode electrode 22.

The conventional FED constructed as described above operates as follows.

First, as for the operation of the FED, when a high voltage is applied from the high voltage power source unit 31 to the anode electrode 22, a scan voltage is applied to the scan electrode 12A and a data voltage is applied to the data electrode 14A.

Then, as pixels selected by the voltages applied to the scan electrode 12A and the data electrode 14A are driven, an image is displayed on a screen.

However, some of electrons discharged from the cathode electrode 12 are not accelerated toward the phosphor-coated anode 22 but collide with the spacer 30 to electrostatically charge the surface of the spacer 30. Namely, the charged electrons can change distribution of a voltage around the spacer 30. In this case, since the change in the voltage distribution around the spacer 30 can distort flow of the discharged electrons, causing degradation of a display state such as a appearance of noise on the screen and visible appearance of a position of the spacer 30 on the screen. In addition, the change in the voltage distribution around the spacer 30 can generate an electric arc between the spacer 30 and the cathode electrode 12.

FIG. 3 is a graph showing a change of voltage applied to the anode electrode of the conventional FED.

As shown in FIG. 3, as for the voltage applied to the anode electrode 22 of the FED, since the anode electrode 22 is directly connected to an input terminal of the high voltage power source unit 31, a DC high voltage of the high voltage power source unit 31 is provided as it is to the anode electrode 22. Namely, in the conventional FED, because there is no discharge path for discharging electric charge charged in the spacer 30, there is a high possibility that a noise is generated on the image displayed on the screen for a predetermined time while the electric charge charged in the spacer 30 is being discharged.

In order to solve such a problem, a ground electrode is formed at a lower end portion of the spacer 30 as shown in FIG. 4.

FIG. 4 is a plan view showing a discharging device of the conventional FED.

With reference to FIG. 4, the discharging device of the conventional FED includes a spacer ground electrode 32 formed at a lower end portion of the spacer 30. However, even though the spacer ground electrode 32 is formed at the lower end portion of the spacer 30 to discharge electric charge charged in the spacer 30, the electric charge is not quickly discharged from the spacer 30. Namely, since the spacer 140 is light-emitted for certain time, the spacer 30 is visible on the screen.

As mentioned above, the conventional FED has the following problems. That is, the electric charge charged in the spacer distorts the field to cause generation of noise on the screen. In addition, discharging time is so long as for the spacer to be visible on the screen due to the electric charge charged in the spacer.

### SUMMARY OF THE INVENTION

Therefore, an object of the present invention is to provide a spacer discharging apparatus and method of an FED (Field Emission Display) capable of preventing generation of noise or visible appearance of a spacer on the screen by forming a discharge path selectively connecting an anode electrode and a spacer ground electrode of an FED and controlling the discharge path.

To achieve these and other advantages and in accordance with the purpose of the present invention, as embodied and broadly described herein, there is provided a spacer discharging apparatus of an FED in which a discharge path is formed to connect an anode electrode and a spacer ground electrode of an FED and a switch unit selectively connects the discharge path.

To achieve the above object, there is also provided a spacer discharging method of an FED, including: forming a discharge path connecting an anode electrode and a spacer ground electrode of an FED; and selectively connecting the formed discharge path to discharge electric charge charged in a spacer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing the construction of an FED in accordance with a conventional art;

FIG. 2 is a plan view showing the construction of an FED in accordance with the conventional art;

FIG. 3 is a graph showing a change of voltage applied to an anode electrode of the FED in accordance with the conventional art;

FIG. 4 is a plan view showing a discharging device of the FED in accordance with the conventional art;

FIG. 5 is a plan view showing a spacer discharging device of an FED in accordance with the present invention;

FIG. 6 is a schematic circuit diagram showing a panel portion of the spacer discharging device of the FED as an equivalent circuit in accordance with the present invention;

FIG. 7 shows another example of the spacer discharging device of the FED in accordance with the present invention;

FIG. 8 is a graph showing one example of a change of a voltage of an anode electrode in FIG. 6 in accordance with the present invention;

FIG. 9 is a graph showing another example of a change of a voltage of an anode electrode in FIG. 6 in accordance with the present invention;

FIG. 10 is a graph showing one example of an anode electrode voltage distribution and a relationship with a vertical synchronous signal in FIG. 7; and

FIG. 11 is a graph showing another example of an anode electrode voltage distribution and a relationship with a vertical synchronous signal in FIG. 7.

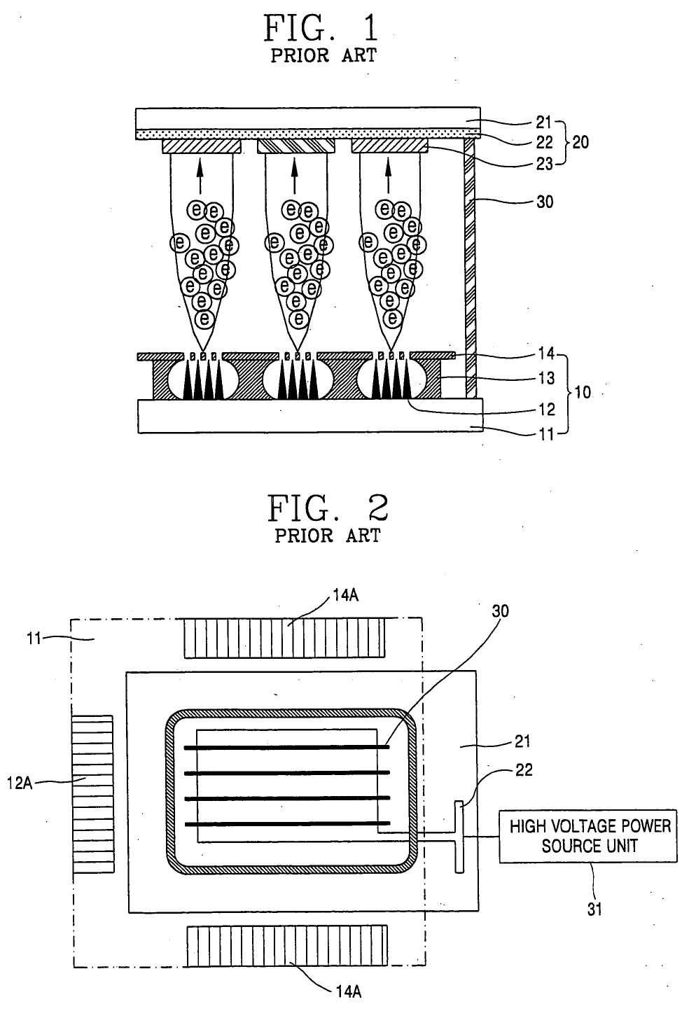

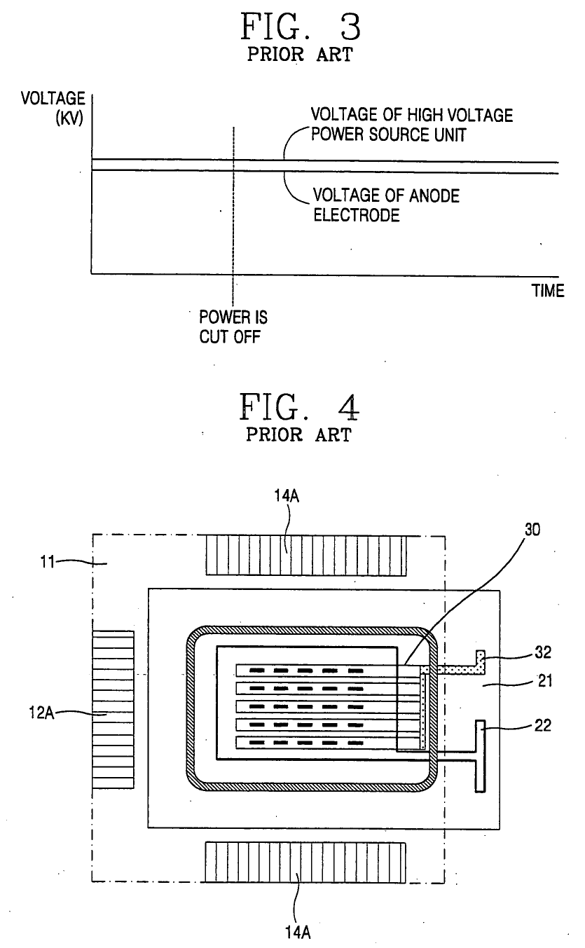

### DETAILED DESCRIPTION OF THE PREFERRED EMBODIMENTS

Reference will now be made in detail to the preferred embodiments of the present invention, examples of which are illustrated in the accompanying drawings.

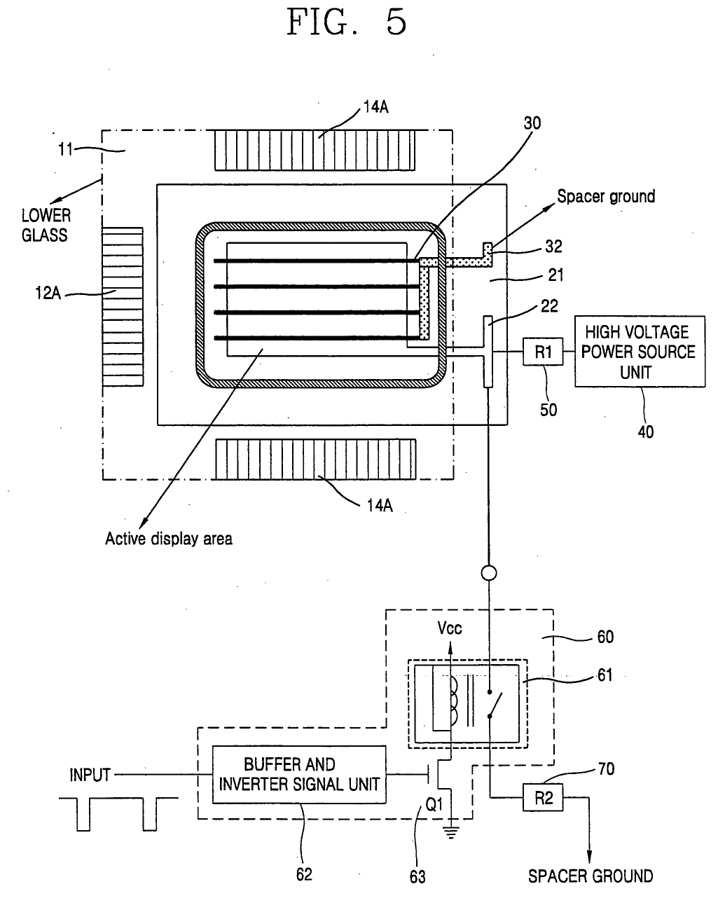

A spacer discharging apparatus and method of an FED (Field Emission Display), which is capable of preventing generation of noise and visible appearance of a spacer on a screen by forming a discharge path for selectively connecting an anode electrode and a spacer ground electrode and controlling the discharge path, in accordance with preferred embodiments of the present invention will now be described with reference to FIGS. 5 to 10.

FIG. 5 is a plan view showing a spacer discharging device of an FED in accordance with the present invention.

As shown in FIG. 5, a spacer discharging apparatus of an FED includes a protection resister R1 50 connected between an anode electrode 22 of the FED and a high voltage power source unit 40 applying a high voltage to the anode electrode 22; a switch unit 60 for forming a discharge path between the anode electrode 22 and a spacer ground electrode 32; and a discharge controlling resister R2 70 connected between the switch unit 60 and the spacer ground electrode 32 and controlling discharge time and a residual voltage.

The switch unit 60 includes a switch 61 for selectively connecting the anode electrode 22 and the spacer ground electrode 32; a buffer and inverter signal unit 62 for outputting a control signal to control the switch 61; and a transistor Q1 63 for outputting a driving current to drive the switch 61 upon receiving a control signal from the buffer and inverter signal unit 62.

As the switch 61 selectively connecting the anode 22 and the spacer ground electrode 32, a switching device, such as a high voltage relay, a high voltage switch or a thyrister, is used.

The spacer discharging apparatus of an FED constructed as described above in accordance with the present invention operates as follows.

With the general spacer discharging apparatus of an FED, electric charge charged in the spacer 30 cannot be quickly discharged merely through connecting the spacer ground electrode 32. In order to overcome this matter, the spacer discharging apparatus of an FED includes the switch unit 60 for selectively turning on/off by connecting in series the anode electrode 22 and the spacer ground electrode 32, thereby quickly discharging electric charge charged in the spacer 30.

As mentioned above, the switch unit 60 includes the buffer and inverter signal unit 62, the transistor Q1 63 and the switch 61, and performs a switching operation to discharge electric charge charged in the spacer 30 during a blanking time period (or during a vertical synchronous signal period) after driving of the FED is completed. The blanking time refers to time during which no image is displayed on a screen of the FED, and also can indicate a pulse duration of a vertical synchronous signal (V sync) designating frame time for displaying one image.

In the spacer discharging apparatus of the FED in accordance with the present invention, a pulse type voltage in synchronization with a vertical synchronous signal, instead of a DC high voltage, is applied to the anode electrode 22 during the blanking time period.

However, when the discharge path is formed between the anode electrode 22 and the spacer ground electrode 32 and the anode electrode 22 and the spacer ground electrode 32 are short, electric charge of a capacitance component charged in the spacer 22 flows to the high voltage power source unit 40 reversely through the anode electrode 22 to give an impact on an internal element inside the high voltage power source unit 40.

In order to protect the high voltage power source unit 40 from the discharge impact, in the present invention, the protection resistor R1 50 having a resistance value of a sufficient size is inserted between the anode electrode 22 and the high voltage power source unit 40, whereby an inrush current generated when the high voltage power source unit 40 supplies a high voltage to the anode electrode 22 can be reduced.

In addition, in the present invention, the discharge controlling resister R2 70 is inserted between the switch unit and the spacer ground electrode, to thereby control discharge time and a residual voltage. Namely, the discharge controlling resister R2 70 controls the voltage remaining after discharging according to a voltage dividing ratio with the protection resister R1, thereby preventing an abnormal light emitting of the spacer and maintaining a certain voltage. Accordingly, insertion of the discharge controlling resister R2 70 can help reduce power consumption for re-charging and a burden of the protection resister R1 50.

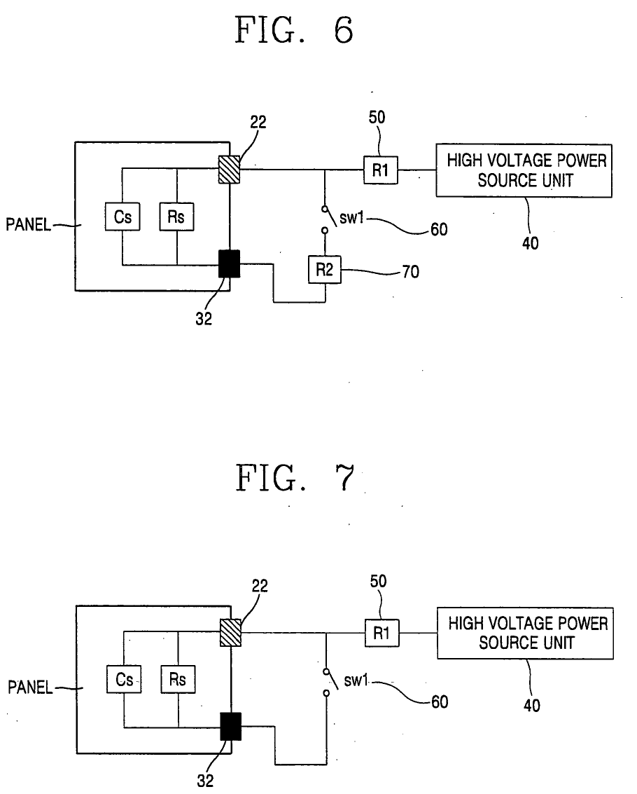

FIG. 6 is a schematic circuit diagram showing a panel portion of the spacer discharging device of the FED as an equivalent circuit in accordance with the present invention.

As shown in FIG. 6, the spacer of the FED panel can be shown as an equivalent circuit in which a resistance component Rs and a capacitance component (Cs) are connected in parallel to the anode electrode 22 and the spacer ground electrode 32. Accordingly, the spacer discharging apparatus of the FED includes the switch unit 60 for controlling a discharge path by selectively connecting the anode electrode 22 and the spacer ground electrode 32; the protection resister R1 50 connected between the anode electrode 22 and the high voltage power source unit 40; and the discharge controlling resister R2 70 connected between the switch unit 60 and the spacer ground electrode 32.

The discharge controlling resister R2 70 needs only be positioned between the anode electrode 22 and the spacer ground electrode 32, it can be positioned between the switch unit 60 and the spacer ground electrode 32 or between the switch unit 60 and the anode electrode 22.

An operation principle according to the construction of the present invention is as follows.

When the spacer 30 is charged as the DC high voltage which has been outputted from the high voltage power source unit 40 is applied to the anode electrode 22, a pulse control signal in synchronization with a vertical synchronous signal (V sync) is applied to the anode electrode 22 during a blanking time period, thereby changing a form of the voltage applied to the anode electrode 22. Namely, as for the form of the voltage of the anode electrode 22, a pulse voltage lower than the actual DC high voltage is applied to the anode electrode 22 during the blanking time period. Accordingly, the spacer discharging apparatus can quickly discharge electric charge charged in the spacer and prevent a phenomenon that the spacer is visible on the screen.

FIG. 7 shows another example of the spacer discharging device of the FED in accordance with the present invention.

As shown in FIG. 7, by removing the discharge controlling resister R2 70 from the construction shown in FIG. 6 of the spacer discharging apparatus of the FED, electric charge charged in the spacer can be more quickly discharged. In this case, however, without the discharge controlling resister R2 70, an impact due to discharging can be applied to the protection resister R1 50, so a value of the protection resister R1 50 must be sufficiently taken into consideration. The protection resister R1 50 preferably has a value of a few K˜scores of M [ohm]. In addition, if the discharge control resister R2 70 is removed, the first resister can be heated and thus power consumption can be increased.

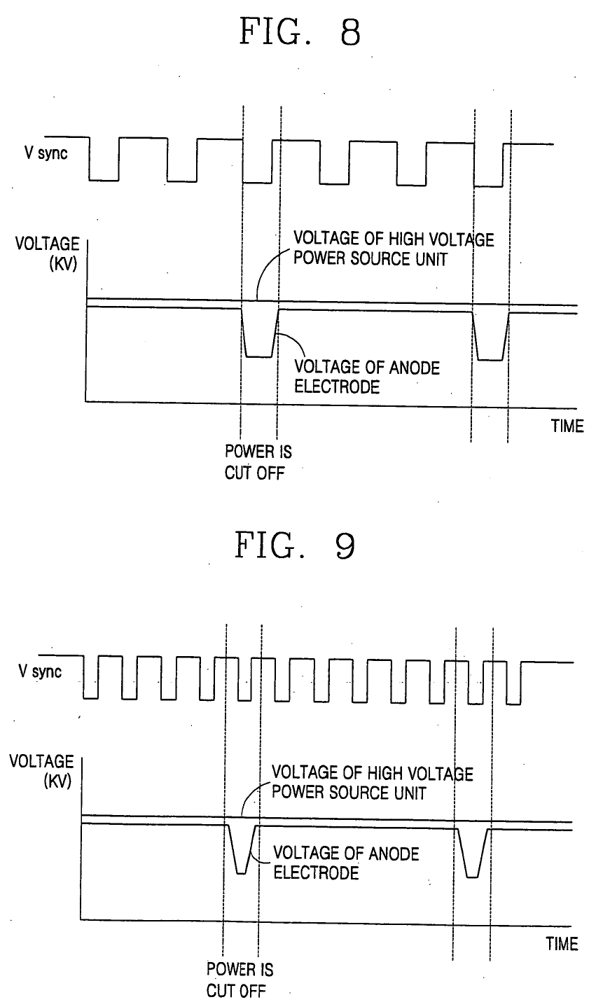

Results obtained by measuring a change of a voltage of an anode electrode of the spacer discharging apparatus of the FED from experimentation will now be described with reference to FIGS. 8˜11.

The spacer discharging apparatus of the present invention utilizes a principle that a pulse control signal in synchronization with a vertical synchronous signal during a blanking time period is applied to the anode electrode 22. In this case, the pulse control signal is repeatedly applied at certain period intervals on the basis of the vertical synchronous signal. The certain period can be variably set depending on a discharge state of the FED or a noise state.

FIGS. 8 and 9 are graphs showing changes of voltages of an anode electrode in FIG. 6 in accordance with the present invention, in which a voltage applied to the anode electrode has an output waveform with a certain size of voltage owing to the voltage dividing ratio between the protection resister R1 50 and the discharge controlling resister R2 70.

FIG. 8 is a graph showing one example of a change of a voltage of an anode electrode in FIG. 6 in accordance with the present invention.

As shown in FIG. 8, the DC high voltage power source outputted from the high voltage output unit is outputted as always the same voltage regardless of a point when a power source for an element is cut off, but a voltage of the anode electrode is quickly dropped to a low voltage at a point when the power source is cut off. In this case, spacer discharging is repeatedly performed for every vertical synchronous signal, that is, a point when the power source is cut off, and it is performed one time for every certain number of vertical synchronous signals (every three vertical synchronous signals herein).

FIG. 9 is a graph showing another example of a change of a voltage of an anode electrode in FIG. 6 in accordance with the present invention.

As shown in FIG. 9, spacer discharging can be performed whenever a plurality of vertical synchronous signals are generated. A period of the spacer discharging can be determined by experimentation while observing abnormal light emitting of the spacer.

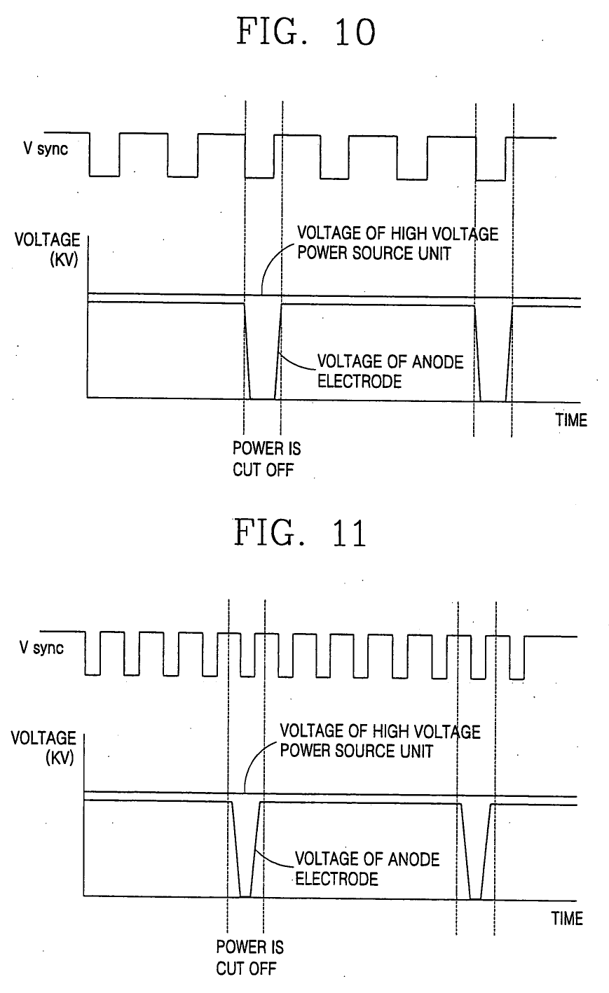

FIGS. 10 and 11 are graphs showing a change of an anode electrode voltage of the construction of FIG. 7, in which a voltage applied to the anode electrode has an output waveform with a voltage size of ‘0’ as a second resister is removed.

FIG. 10 is a graph showing one example of an anode electrode voltage distribution and a relationship with a vertical synchronous signal in FIG. 7.

As shown in FIG. 10, spacer discharging is performed one time when a plurality of vertical synchronous signals (three ones herein) are generated. Since the spacer discharging apparatus of the present invention does not include the second resister, the spacer can be completely discharged after the voltage is cut off. Thus, an abnormal light-emitting phenomenon of the spacer can be prevented.

FIG. 11 is a graph showing another example of an anode electrode voltage distribution and a relationship with a vertical synchronous signal in FIG. 7.

As shown in FIG. 11, in the spacer discharging apparatus of the present invention, spacer discharging is performed one time when a plurality of vertical synchronous signals (six ones herein), so that power consumption is low and heating of the element (especially, the protection resister (R1)) is reduced compared to-the case of FIG. 10.

As so far described, the spacer discharging apparatus and method of an FED in accordance with the present invention have the following advantages.

That is, for example, since the discharge path connecting the anode electrode and the spacer ground electrode is formed and a pulse control signal in synchronization with a vertical synchronous signal is outputted during a blanking time period to selectively connect the discharge path, electric charge charged in the spacer can be quickly discharged. Thus, generation of noise on a screen can be prevented, generation of arc due to a high voltage or abnormal light emitting can be also prevented, and in addition, a visible appearance of the spacer can be prevented. Therefore, a picture quality of a displayed image can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A spacer discharging apparatus of an FED, comprising:
a discharge path for connecting an anode electrode and a spacer ground electrode of an FED; and
a switch unit for selectively connecting the discharge path to discharge electric charge charged in a spacer of the FED.

2. The apparatus of claim 1, wherein the switch unit is connected in series between the anode electrode and the spacer ground electrode and selectively turned on/off.

3. The apparatus of claim 1, wherein the switch unit applies a pulse control signal in synchronization with a vertical synchronous signal to the anode electrode during an interval where a voltage applied to the anode electrode is cut off.

4. The apparatus of claim 1, wherein the switch unit applies a pulse control signal in synchronization with a vertical synchronous signal to the anode electrode during a blanking time period.

5. The apparatus of claim 4, wherein the blanking time period indicates time during which no image is displayed on a screen of the FED or a pulse duration of the vertical synchronous signal (V sync).

6. The apparatus of claim 4, wherein the pulse control signal is repeatedly applied at certain period intervals on the basis of the vertical synchronous signal.

7. The apparatus of claim 6, wherein the certain period is determined depending on a discharge state or a noise state of the FED.

8. The apparatus of claim 1, wherein the switch unit comprises:
a switch for selectively connecting the anode electrode and the spacer ground electrode;
a buffer and inverter signal unit for outputting a control signal to control the switch; and
a transistor for outputting a driving current to drive the switch upon receiving a control signal from the buffer and inverter signal unit.

9. The apparatus of claim 8, wherein the switch is one of a high voltage relay, a high voltage switch and thyrister.

10. The apparatus of claim 9, wherein the switch is turned on when a current flows to the transistor, and turned off when no current flows to the transistor.

11. The apparatus of claim 1, further comprising:
a protection resister connected between the anode electrode and a high voltage power source unit applying a high voltage to the anode electrode.

12. The apparatus of claim 11, wherein the protection resister has a resistance value of a few K˜scores of M[ohm].

13. The apparatus of claim 11, further comprising:
a discharge controlling resister for controlling discharge time and a residual voltage.

14. The apparatus of claim 13, wherein the discharge controlling resister is connected between the switch unit and the spacer ground electrode.

15. The apparatus of claim 13, wherein the discharge controlling resister is connected between the switch unit and the anode electrode.

16. A spacer discharging method of an FED comprising:
forming a discharge path connecting an anode electrode and a spacer ground electrode of an FED; and
selectively connecting the formed discharge path to discharge electric charge charged in a spacer.

17. The method of claim 16, wherein in order to discharge electric charge from the spacer, a pulse control signal in synchronization with a vertical synchronous signal is applied to the anode electrode during a blanking time period.

18. The method of claim 17, wherein the pulse control signal is repeatedly applied at certain period intervals according to a discharge state or a noise state of the FED.

19. The method of claim 16, wherein in order to form the discharge path, a protection resister is connected between the anode electrode and a high voltage power source unit for applying a high voltage to the anode electrode.

20. The method of claim 19, wherein in order to form the discharge path, a discharge controlling resister for controlling discharge time and a residual voltage is additionally connected between the anode electrode and the spacer ground electrode.
